(19) United States
(12) Patent Application Publication
(10) Pub. No.: US 2026/0170087 A1
(43) Pub. Date: Jun. 18, 2026

(54) METHODS FOR REGION FEATURE DETERMINATION

(71) Applicant: CarbonCo Limited, 7010 (NZ)

(72) Inventors: Nicholas David BUTCHER, Nelson (NZ); Nick BURNS, Nelson (NZ); Crispin David Lovell-Smith, Nelson (NZ); Hannes Till Hille, Nelson (NZ); Julian Roscoe Maclaren, Nelson (NZ)

(21) Appl. No.: 19/128,558

(22) PCT Filed: Nov. 8, 2023
(86) PCT No.: PCT/IB2023/061294

§ 371 Date: May 8, 2025

Related U.S. Application Data
(60) Provisional application No. 63/423,613, filed on Nov. 8, 2022.

(51) Int. Cl. G06F 18/214; G06F 18/22; G06N 3/08; G06N 20/00; G06T 7/00; G06T 7/11

(52) U.S. Cl. CPC G06F 18/214; G06F 18/22; G06N 3/08; G06N 20/00; G06T 7/0002; G06T 7/11; G06T 2207/20081

(57) ABSTRACT

A method for determining a value for a feature of an inspection region, the method comprising: obtaining imagery, the imagery relating to an inspection region; obtaining data, the data relating to the inspection region and corresponding to one or more features of a plurality of features; determining one or more reference regions different from the inspection region; and deter-mining, based on the one or more reference regions, a value for a feature of the inspection region.

### FIELD

This relates to methods for the determination of features for a region.

### BACKGROUND

Regions have various features for which data can be collected and stored for use.

### SUMMARY

In an example embodiment, there is provided a method for determining a value for a feature of an inspection region, the method comprising: obtaining imagery, the imagery relating to an inspection region; obtaining data, the data relating to the inspection region and corresponding to one or more features of a plurality of features; determining one or more reference regions different from the inspection region; and determining, based on the one or more reference regions, a value for a feature of the inspection region.

### BRIEF DESCRIPTION

The description is framed by way of example with reference to the drawings which show certain embodiments. However, these drawings are provided for illustration only, and do not exhaustively set out all embodiments.

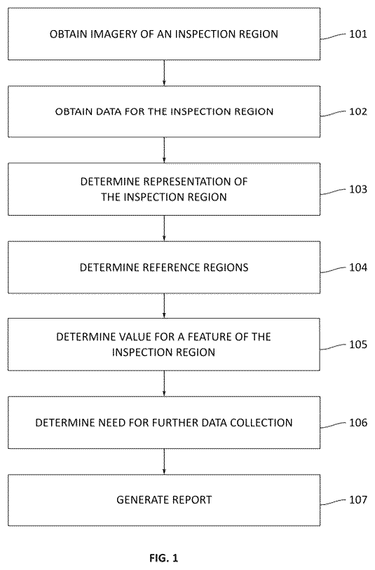

FIG. 1 shows an example method for determining a value for a feature of a region.

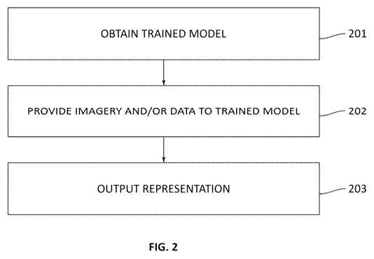

FIG. 2 shows an example process for obtaining an embedding vector from imagery and data.

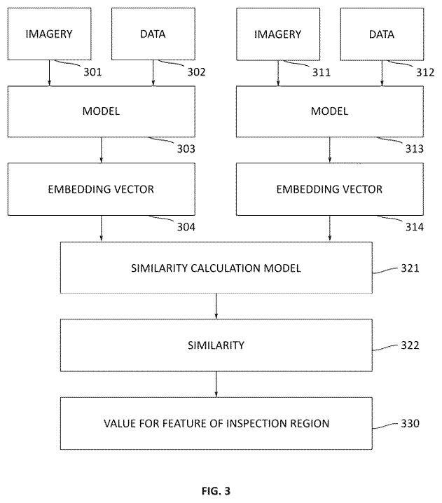

FIG. 3 shows information flows in the methods described below.

Further details of aspects of these methods are described below. These methods and the description below may be used to implement the methods described in the claims.

### DETAILED DESCRIPTION

Methods are described for determining a value for a feature of a region of land. This value may be an estimate of a future value, and may preferably relate to the vegetation of the region. This is achieved by acquiring data relating to features of the region. This is obtained by imagery and/or by other data collection methods. By identifying other, preferably similar, reference regions, the values for features of the inspection region can be estimated. The reference regions are those which have been previously processed and stored in a database. These methods also apply over time, so that future changes can be estimated, based on known changes that have already taken place to reference regions.

“Vegetation” is used here in its broadest sense. It may comprise flora, such as tree species and grass species, but also includes a lack of such flora. For example, bare soil with no growth visible is included, as are rocky surfaces, such as scree. Snow cover, which may or may not exist during all seasons, is also included. It also includes wetlands, which may or may not be completely covered in water with no growth visible. In this sense, the term “vegetation” may encompass any aspect of an area of land.

A “region” comprises any geographically bound area of land. This may be expressed as a set of coordinate points. This may be two-dimensional, and relate only the latitude and longitude of the points. In some cases, this may be three-dimensional, and may include altitude, which may be above, below, or at the surface of the land. In this way, a region of land may be a three-dimensional area. In some cases, the region of land may be non-contiguous and/or may exclude some interior portions of the land.

A “feature” of a region of land is used in its broadest sense, and comprises any information about the land, what is in or on the land, what occurs to the land, how the land is used, and externalities of the land.

Features may comprise one or more of latitude, longitude, climate, temperature, rainfall, wind speed, humidity, elevation above sea level, topography, soil type, vegetation species mix, vegetation height, vegetation age, carbon stock, carbon sequestration rate, habitat sustainability, and fauna species presence.

Features may additionally or alternatively comprise land use and land use changes. These can include activities such as grazing, modifications to livestock density or type, spraying, burning, fencing, planting, pest control, irrigation, modifications to drainage or flood control, or application of fertilizer.

FIG. 1 shows an example method for determining a value for a feature of a region.

While this method is described in relation to a single value for a single feature for simplicity of description, this same method may be used to determine multiple values for a feature, or for determining one or more values for multiple features. This can be done at the same time, or in subsequent applications of the method.

At step 101, imagery of an inspection region is obtained.

An inspection region is a region for which a value will be determined. This may be because the value is not available as the result of direct data collection. One reason for this may be that the value is in the future (and so direct data collection at present is impossible).

Imagery comprises one or more images obtained of at least part of the region.

This may comprise optical images, such as satellite images, aerial photography, ground-based photography, drone footage, or hyperspectral images. This may additionally or alternatively comprise non-optical images such as LIDAR data or synthetic aperture radar (SAR) data. Some specific examples of imagery comprise raw Sentinel bands, NDVI, moisture index, and a digital elevation map.

The imagery may comprise images of the same region or portion of the region over time. For example, multiple optical images may be obtained periodically.

At step 102, data for the inspection region is obtained.

The data relates to one or more features. For example, the data may comprise temperature data which relates to the temperature of the region. Each part of the data may relate to all or a portion of the region.

The format of the data may vary depending on the feature it relates to. It may be a single value, a sequence of values, a matrix of values, free text, or any other form. In addition, the data may be time-based. For example, the data may comprise data of the same feature of the same region or portion of the region at different points in time. The source of the data may be existing databases, may be collected by individuals, may be obtained through publications, or through any other means.

At step 103, a representation of the inspection region is determined.

A “representation” is a form of the imagery and the data which has been processed into a standardized format. The representation may be a format which can be compared to other representations in a simpler, more mathematically or computationally feasible manner, compared to the initial data.

In a preferred embodiment, the representation is one or more embedding vectors. Each embedding vector corresponds to values for one or more features. An example method for obtaining an embedding vector is shown in FIG. 2.

In the case of imagery, the embedding vector may comprise a matrix with values corresponding to pixels in an image. For example, for an input image having dimensions 256×256 and having three color channels, this may result in a matrix having dimensions 256×256×112.

In some embodiments, the representation comprises a set of one or more embedding vectors corresponding to a feature (or a plurality of features) which vary across a time range. That is, each vector in the set corresponds to the same feature or features, but at a different time in the time range. The time range may be different for different features. That is, a first set may correspond to a first time range, and a second set may correspond to a second time range different from the first time range. This may allow for the representation to show changes in time based on the availability of data for each feature.

At step 104, one or more reference regions are determined. The one or more reference regions are different from the inspection region.

A reference region is a region for which data has been previously obtained. The data may be from a verified data source: that is, obtained through direct measurement by a trusted party such as a user or by the operator of the method. The data may additionally or alternatively be from a synthetic data source: that is, obtained from a third party.

In some embodiments, a similarity is calculated between the inspection region and each of one or more reference regions. Example approaches for determining the similarity of the inspection region and a reference region are described below. Based on the similarity, a subset of the reference regions is identified.

This may comprise identifying the reference regions having a similarity above a threshold similarity. In this case, the threshold similarity may be predetermined or may be selected programmatically based on testing to identify a threshold similarity which provides a sufficiently accurate result.

This may additionally or alternatively comprise identifying the reference regions with the highest similarity to produce a number of reference regions or a percentage of the reference regions. The number or percentage may be predetermined or may be selected programmatically based on testing to identify a number or percentage which provides a sufficiently accurate result.

In some embodiments, only those reference regions which match criteria may be selected. The criteria may relate to provenance. This may be that the data for the reference region was obtained from a source having certain characteristics, such as trustworthiness or accuracy. Additionally or alternatively, this may be the data for the reference region was obtained from a predetermined list of sources (such as a whitelist), or that the data for the reference region was not obtained from a predetermined list of sources (such as a blacklist).

At step 105, a value for a feature of the inspection region is determined based on the one or more reference regions.

The feature may be calculated as a combination of the corresponding values of each of the reference regions. In this way, an unknown value for the inspection region can be calculated on the basis of the corresponding values for similar regions. This can result in an accurate value for the feature in a situation where direct data for that feature is not available.

The combination may be based on a weighted function, where the contribution of each reference region towards the calculated value is not the same. The weights may be based on the similarity of the reference regions to the inspection region. In this way, more similar reference regions more strongly affect the calculated value than less similar reference regions.

The weights may additionally or alternatively based on the similarity of the feature of the reference regions to the inspection region. That is, even for reference regions which are not similar overall, they may be weighted highly if the feature is similar.

The weights may additionally or alternatively be based on the provenance of the data, for example based on the trustworthiness or accuracy of the data. In one example, where the data is from a verified data source based on ground truth, this may have a higher weighting compared to a synthetic data source obtained from a third party data source.

In some embodiments, the value may comprise a range of values. In some cases, this may result in a higher accuracy, as the actual value (if measured) may be more likely to fall within a range of values. The range of values may be identified based on a predetermined confidence level, where a higher confidence value may lead to a larger range.

In some embodiments, the value may comprise a certainty value. The certainty value indicates the estimated likelihood that the calculated value is accurate. This may be based on the variance of the reference regions in this respect. That is, where the reference regions vary widely, this may result in a lower certainty value, and where the reference regions are consistent, this may result in a higher certainty value.

In some embodiments, the value may correspond to a future time period. In this manner, the value may be calculated based on the trends of the feature in the similar reference regions over comparable time periods in the past.

At step 106, a need for further data collection is determined.

This may occur where the certainty value is below a threshold or if the variance of the reference regions is above a threshold. In these situations, while a value may be calculated at step 105, such a value may not be sufficiently certain.

In response, an indication may be provided to a user. This may comprise a location at which a user should obtain further imagery and/or obtain further data.

In some cases, this may result in further imagery and/or data being obtained without user intervention. For example, a drone may be dispatched to obtain further imagery and/or further data to a location which would provide a higher certainty value.

Step 106 may be omitted in some embodiments.

At step 107, a report is generated based on the value. The report may indicate the value for the feature for the region.

In one example, the feature may be future carbon sequestration: that is, an estimate of the carbon sequestered by a region at a point in the future. In another example, the feature may be species composition and/or vegetation level in the past, presently, or in the future.

The report may further comprise data about the reference regions, such as a map and imagery and/or data for those reference regions. This may provide visual indication that the calculated value is accurate.

This report may be provided in a human-readable format, which allows for a user to understand the value and the basis for the calculation of the value. This report may additionally or alternatively be provided in a computer-readable format, which may be used as an input to an automated process, for example relating to carbon credits.

Step 107 may be omitted in some embodiments.

Through the method shown in FIG. 1, a value for an inspection region can be calculated even without ground truth data for that value. This may be highly accurate through the use of similar reference regions, and may therefore provide an efficient, scalable system for the calculation of data about an inspection region without direct data collection.

FIG. 2 shows an example method for obtaining an embedding vector from imagery and data.

At step 201, a trained model is obtained.

The trained model may be obtained through supervised, semi-supervised, or unsupervised training, and may be a deep learning model such as an artificial neural network. Thus, in one example, a labelled training set is provided to a model for training. The labelled training set comprises imagery and/or data for one or more training regions. These may be verified labelled examples based on a ground truth: that is, obtained through direct measurement by a trusted party such as a user or by the operator of the method. These may additionally or alternatively be synthetic labelled examples: that is, obtained from a third party where the accuracy may not be confirmed. In some cases, only data meeting eligibility criteria may be used. The eligibility criteria may be that the data has been verified by a trusted party.

In another example, an unlabeled training set may be provided to a model for training. The unlabeled training set comprises imagery and/or data for one or more training regions.

In some embodiments, the training regions may be different from the reference regions and/or from the inspection region. This may reduce the risk of overtraining and may provide a higher accuracy approach.

In some embodiments, the model may be trained so as to optimize the resultant embedding vector's usefulness in determining the similarity of regions in a particular subset of features. For example, a feature such as carbon stock or carbon sequestration rate may be prioritized, even if this results in a lower accuracy for other features.

The result of step 201 is a trained model. In some cases, a separate trained model may be used for each feature, or for a combination of features.

At step 202, the imagery and/or data for the inspection region is provided to the trained model.

The imagery and/or data may be provided in the same format as the data of the training sets.

At step 203, the output of the trained model is provided.

The output of the trained model comprises one or more embedding vectors. The one or more embedding vectors which are output may relate only to a subset of the features. In this case, the method of FIG. 2 may be repeated for other features: either using the same or another trained model. This results in one or more embedding vectors for the inspection region.

Steps 202 and 203 may be repeated as needed using the same trained model produced in step 201. However, step 201 may be repeated as needed. For example, if the training set has changed, it may be useful to retrain the model by repeating step 201.

### Similarity

A similarity may be calculated between the inspection region and a reference region, or between a feature of the inspection region and a feature of the reference region.

The similarity may be based on a representation of the inspection region and a corresponding representation of the reference region. A representation for a reference region may to obtained using the method of FIG. 2. The representation comprises embedding vectors comprising numerical values. The similarity may be calculated as the inverse of the distance between an embedding vector for the inspection region and the corresponding embedding vector for the reference region. This may be calculated using squared error or cosine similarity between the corresponding embedding vectors.

For example, in the case of imagery, the embedding vector may be a matrix, where values of the matrix correspond to pixels in the imagery. The distance between the two matrices, and consequently the similarity between the imagery of the inspection region and the reference region, may be calculated, for example using squared error or cosine similarity. This allows the mathematically and computationally simple calculation of the similarity of the imagery.

Similarity may be calculated separately for each feature or subset of features. These similarities may be combined to calculate an overall similarity between the inspection region and the reference region, for example by a normalized and/or weighted average of the similarities.

In some cases, the similarity may be based on changes over time. For example, the representation of a reference region may comprise one or more embedding vectors which show the change of a feature over time. These may be interpolated (for example, linearly interpolated) to provide a continuous interpolation of values based on discrete values. This may be compared to the corresponding one or more embedding vectors of the inspection region, which may be for a shorter period of time. The similarity calculation therefore indicates whether the feature is similar over the common period of time. This may have particular value when the methods described above are used for the estimation of a future value of a feature of the inspection region.

A further application of similarity may be to confirm the validity of the training set used in the method of FIG. 2. The similarity between pairs of regions in the training set may be calculated. Where this results in a high similarity, but the labels for the regions in the training set are different, this may indicate a problem. For example, the training set labels may be incorrect, may comprise outliers, or the imagery and/or data for the regions is insufficient quality. This may guide further data collection, for example using the approach of step 106. This may additionally or alternative guide training of the model obtained at step 201.

### Data Flows

FIG. 3 shows an example of data flows which may occur during the methods described above.

Imagery 301 and/or data 302 for an inspection region are passed into a model 303 (such as that obtained at step 201). This results in an embedding vector 304.

Similarly, imagery 311 and/or data 312 for a reference region are passed into a model 313 (such as that obtained at 201, and which may be the same as model 303). This results in an embedding vector 314. This may occur for a plurality of reference regions.

Embedding vector 304 and a plurality of embedding vectors 314 are passed into a similarity calculation model 320 to provide a similarity calculation 321 for each reference region. This is used to identify a subset of reference regions 322. The value 330 for the feature of the inspection region is then output based on the subset of the reference regions.

### Interpretation

A number of methods have been described above. Any of these methods may be embodied in a series of instructions, which may form a computer program. These instructions, or this computer program, may be stored on a computer readable medium, which may be non-transitory. When executed, these instructions or this program cause a processor to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The steps of the methods have been described in a particular order for ease of understanding. However, the steps can be performed in a different order from that specified, or with steps being performed in parallel. This is the case in all methods except where one step is dependent on another having been performed.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1. A method for determining a value for a feature of an inspection region, the method comprising:
obtaining imagery, the imagery relating to an inspection region;
obtaining data, the data relating to the inspection region and corresponding to one or more features of a plurality of features;
determining one or more reference regions different from the inspection region, wherein determining one or more reference regions comprises determining a representation of the inspection region; and
determining, based on the one or more reference regions, a value for a feature of the inspection region,
wherein the value comprises a certainty value, the method further comprising:
determining that further data collection is needed based on the value; and
providing an indication of a location for the further data collection.

2. (canceled)

3. The method of claim 1, wherein the representation comprises one or more embedding vectors,
wherein the one or more embedding vectors comprises a matrix of pixel values of the imagery, and
wherein determining a representation of the inspection region comprises:
determining one or more embedding vectors, each vector corresponding to at least one feature of the plurality of features;
determining a first set of embedding vectors comprising one or more embedding vectors corresponding to a first feature of the plurality of features and to a first time range, each vector of the first set of embedding vectors corresponding to a different time in the time range; and
determining a second set of embedding vectors comprising one or more embedding vectors corresponding to a second feature of the plurality of features different from the first feature and to a second time range, each vector of the second set of embedding vectors corresponding to a different time in the time range.

4. (canceled)

5. (canceled)

6. (canceled)

7. (canceled)

8. The method of claim 3, wherein the first time range is different from the second time range.

9. The method of claim 1, wherein determining a representation comprises:
providing the imagery and/or the data to one or more trained models; and
obtaining the output of the one or more trained models, the output of each of the one or more trained models comprising the one or more embedding vectors.

10. (canceled)

11. The method of claim 9, the method further comprising:
obtaining labelled data, the labelled data comprising data for one or more regions;
training a model based on the labelled data to produce the trained model.

12. The method of claim 11, wherein the labelled data comprises labels from one of more of the group consisting of:
verified labelled examples based on ground truth;
synthetic labelled examples; and
labelled data meeting eligibility criteria.

13. (canceled)

14. (canceled)

15. The method of claim 1, the method further comprising:
obtaining unlabelled data, the unlabelled data comprising data for one or more regions;
training a model based on the unlabelled data to produce the trained model.

16. The method of claim 1, wherein determining one or more reference regions different from the inspection region comprises:
calculating a similarity between the inspection region and one or more reference regions.

17. The method of claim 16, wherein the similarity is calculated using squared error.

18. The method of claim 16, wherein the similarity is calculated using cosine similarity.

19. The method of claim 16, wherein determining one or more reference regions different from the inspection region further comprises one of more of the group consisting of:
identifying a subset of the reference regions based on the similarity;
identifying a subset of the reference regions based on the similarity being above a threshold similarity; and
identifying the subset based on the reference regions with the highest similarity.

20. (canceled)

21. (canceled)

22. The method of claim 19, wherein the subset of the reference regions comprises a subset of the reference regions meeting provenance criteria.

23. The method of claim 1, wherein determining, based on the one or more reference regions, a value for a feature of the inspection region comprises:
calculating the value as a combination of the corresponding values of each of the one or more reference regions.

24. The method of claim 23, wherein the combination is a weighted function,
wherein weights of the weighted function are based on the similarity between the inspection region and the reference region,
wherein the weights are based on the similarity of between the feature of the inspection region and the feature of the reference region, and
wherein the weights are based on a provenance for each reference region.

25. (canceled)

26. (canceled)

27. (canceled)

28. The method of claim 1, wherein the value for a feature of the inspection region relates to a future value.

29. The method of claim 1, the method further comprising:
generating a report based on the value, the report comprising a calculation of future carbon sequestration.

30. (canceled)

31. (canceled)

32. (canceled)

33. (canceled)

34. The method of claim 1, wherein the imagery is selected from the group consisting of:
satellite images;
aerial photography;
ground-based photography;
drone footage;
hyperspectral images;
LIDAR data; and
synthetic aperture radar data,
wherein the feature of the inspection region is selected from the group consisting of:
vegetation species mix;
vegetation height;
vegetation age;
carbon stock;
carbon sequestration rate;
habitat sustainability; and
fauna species presence, and
wherein the data comprises data for one or more of:
latitude;
longitude;
climate;
temperature;
rainfall;
wind speed;
humidity;
elevation above sea level;
topography;
land use;
soil type;
vegetation species mix;
vegetation height;
vegetation age;
carbon stock;
carbon sequestration rate;
habitat sustainability; and
fauna species presence.

35. (canceled)

36. (canceled)

37. A system configured to implement the method of claim 1.

38. Computer readable medium comprising instructions which, when executed by one or more processors, cause the one or more processors to perform the method of claim 1.
